(19) United States
(12) Patent Application Publication
(10) Pub. No.: US 2022/0410904 A1
(43) Pub. Date: Dec. 29, 2022

(54) INFORMATION PROCESSING DEVICE, INFORMATION PROCESSING SYSTEM AND INFORMATION PROCESSING METHOD

(71) Applicant: Sony Group Corporation, Tokyo (JP)

(72) Inventors: Kentaro DOBA, Tokyo (JP); Toshio YAMAZAKI, Tokyo (JP)

(73) Assignee: Sony Group Corporation, Tokyo (JP)

(21) Appl. No.: 17/765,004

(22) PCT Filed: Oct. 6, 2020
(86) PCT No.: PCT/JP2020/037809

§ 371 Date: Mar. 30, 2022

(30) Foreign Application Priority Data
Oct. 31, 2019 (JP) 2019-198114

(51) Int. Cl. B60W 40/02; B60W 50/00

(52) U.S. Cl. CPC B60W 40/02; B60W 50/0097; B60W 2420/42; B60W 2420/52

(57) ABSTRACT

The information processing device (100) includes a storing unit (120) that stores parameter information (D1) concerning parameters used for detection of the surrounding environment of a mobile body (500) and a setting unit (132) that sets, based on dynamic information (a dynamic map D100) detected outside the mobile body (500) and the parameter information (D1), the parameters used for the detection of the surrounding environment of the mobile body (500).

### FIELD

The present disclosure relates to an information processing device, an information processing system, and an information processing method.

### BACKGROUND

The mobile body improves the safety of movement by using a detection result of a surrounding environment. Patent Document 1 discloses a technique for controlling processing based on a comparison result of information concerning a mobile body detected by a detecting unit and information concerning a mobile body detected by an external device.

### CITATION LIST

### Patent Literature

Patent Literature 1: WO 2017/029847 A

### SUMMARY

### Technical Problem

In the above-mentioned conventional technique, when parameters are used for detection of the surrounding environment of the mobile body, the parameters are divided into parameters suitable for an environment and a situation of the mobile body and parameters not suitable for the environment and the situation of the mobile body. For this reason, in the prior art, it is desired to use parameters suitable for the environment and situation in which the mobile body is moving to detect the surrounding environment of the mobile body.

Therefore, the present disclosure provides an information processing device, an information processing system, and an information processing method that can set parameters suitable for detecting a surrounding environment of a mobile body.

### Solution to Problem

To solve the problems described above, an information processing device according to an embodiment of the present disclosure includes: a storing unit that stores parameter information concerning parameters used for detection of a surrounding environment of a mobile body; and a setting unit that sets the parameters used for the detection of the surrounding environment of the mobile body based on dynamic information detected outside the mobile body and the parameter information.

Moreover, an information processing system according to an embodiment of the present disclosure includes: an information processing device; and a providing device that provides parameter information concerning parameters used for detection of a surrounding environment of a mobile body to the information processing device, wherein the information processing device includes: a storing unit that stores the parameter information provided by the providing device; and a setting unit that sets, based on dynamic information detected outside the mobile body and the parameter information, the parameters used for the detection of the surrounding environment of the mobile body.

Moreover, an information processing method according to an embodiment of the present disclosure, by a computer, includes: storing parameter information concerning parameters used for detection of a surrounding environment of a mobile body in a storing unit; and setting, based on dynamic information detected outside the mobile body and the parameter information, the parameters used for the detection of the surrounding environment of the mobile body.

### BRIEF DESCRIPTION OF DRAWINGS

FIG. 1 is a diagram for explaining an example of realizing an information processing method according to a first embodiment.

FIG. 2 is a diagram for explaining an example of a dynamic map used in the information processing method.

FIG. 3 is a configuration diagram illustrating an example of the configurations of a mobile body and an information processing device according to the first embodiment.

FIG. 4 is a configuration diagram illustrating an example of the configuration of a first server according to the first embodiment.

FIG. 5 is a configuration diagram illustrating an example of the configuration of a second server according to the first embodiment.

FIG. 6 is a diagram illustrating an example of parameters of parameter information according to the first embodiment.

FIG. 7 is a diagram illustrating an example of a table of parameter information according to the first embodiment.

FIG. 8 is a sequence chart illustrating an example of a processing procedure of an information processing system according to the first embodiment.

FIG. 9 is a flowchart illustrating an example of a processing procedure for changing parameters of the information processing device according to the first embodiment.

FIG. 10 is a diagram for explaining an example of changing parameters and importance degrees according to the first embodiment.

FIG. 11 is a diagram for explaining an example of changing importance degrees by risk degree determination of the information processing device according to the first embodiment.

FIG. 12 is a sequence chart illustrating an example of feedback of the information processing system according to the first embodiment.

FIG. 13 is a flowchart illustrating an example of a processing procedure for reflecting parameter information of the information processing device according to the first embodiment.

FIG. 14 is a diagram for explaining an example of reflecting parameter information.

FIG. 15 is a flowchart illustrating an example of a processing procedure for reflecting parameter information of an information processing device according to a modified example of the first embodiment.

FIG. 16 is a diagram for explaining an example of realizing an information processing method according to a second embodiment.

FIG. 17 is a configuration diagram illustrating an example of the configuration of a roadside machine according to the second embodiment.

FIG. 18 is a sequence chart illustrating an example of feedback of an information processing system according to the second embodiment.

FIG. 19 is a hardware configuration diagram illustrating an example of a computer that realizes the functions of an information processing device.

### DESCRIPTION OF EMBODIMENTS

Embodiments of the present disclosure are explained in detail below with reference to the drawings. Note that, in the embodiments explained below, redundant explanation is omitted by denoting the same parts with the same reference numerals and signs.

### First Embodiment

[Overview of Information Processing System According to First Embodiment]

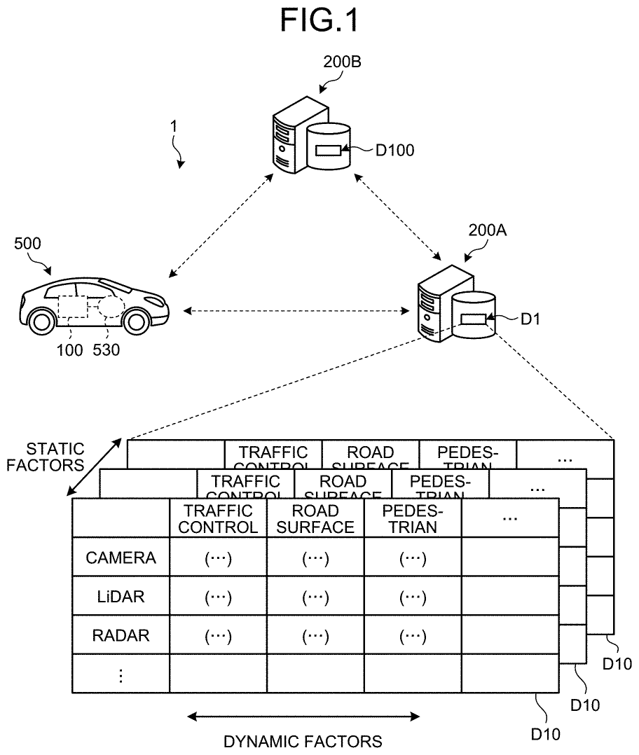

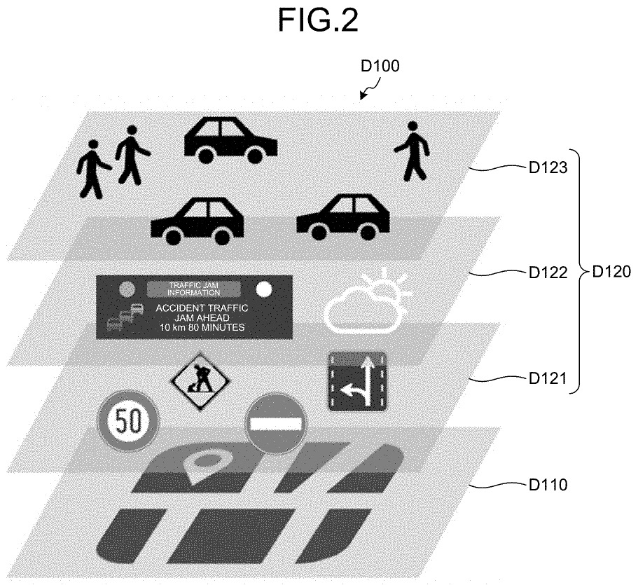

FIG. 1 is a diagram for explaining an example of realizing an information processing method according to a first embodiment. FIG. 2 is a diagram for explaining an example of a dynamic map used in the information processing method.

As illustrated in FIG. 1, an information processing system 1 includes an information processing device 100 mounted on a mobile body 500, a first server 200A, and a second server 200B. The mobile body 500 includes, for example, a vehicle (an automobile, an electric vehicle, a motorcycle, a bicycle, and the like), a mobile robot, and a flying robot (a drone and the like). Note that, in this embodiment, a case where the mobile body 500 is a four-wheeled vehicle is explained. The information processing device 100, the first server 200A, and the second server 200B have a configuration capable of, for example, communicating via a network or directly communicating not via the network.

Note that the information processing system 1 according to the present embodiment can use V2X communication. The V2X communication is communication between the mobile body 500 and “something”. In the information processing system 1, communication between the mobile body 500 and the mobile body 500 is the V2V (Vehicle-to-Vehicle) communication. In the information processing system 1, communication between the mobile body 500 and an infrastructure is V2I (Vehicle-to-Infrastructure) communication. In the information processing system 1, communication between the mobile body 500 and a network is V2N (Vehicle-to-Network) communication. In the information processing system 1, communication between the mobile body 500 and a pedestrian is V2P (Vehicle-to-Pedestrian) communication.

The mobile body 500 is mounted with an on-board device 530. The on-board device 530 includes, for example, electronic equipment such as a sensor, a camera, and a communication device. The electronic equipment of the on-board device 530 detects a surrounding environment of the mobile body 500. The on-board device 530 operates based on parameters. The parameters are used for detection of the surrounding environment of the mobile body 500. The parameters include, for example, parameters such as an effective angle of view, the number of sensors, exposure correction, an image processing filter, and MIMO (Multiple-Input and Multiple-Output). The on-board device 530 has a configuration capable of exchanging information with, for example, an information processing device 100 and the like. The on-board device 530 detects external and internal information of the mobile body 500 and supplies a detection result to the mobile body 500, the information processing device 100, and the like. The mobile body 500 performs driving support, automatic drive, and the like by using the detection result of the on-board device 530.

The first server 200A is, for example, a so-called Cloud server (Cloud Server) and is a server device that executes information processing in cooperation with the information processing device 100. The first server 200A is a device provided outside the mobile body 500. The first server 200A has, for example, a function of providing parameter information D1 used in the mobile body 500. The first server 200A is a server device and is an example of a providing device.

Parameter information D1 is information indicating parameters corresponding to static factors and dynamic factors. The parameter information D1 has, for example, a plurality of tables D10. The plurality of tables D10 are tables corresponding to the static factors. The static factors include factors that do not change at every moment such as countries, regions, seasons, and weathers. Each of the plurality of tables D10 has items corresponding to the dynamic factors and parameters corresponding to a control target. The dynamic factors include factors that change at every moment such as traffic rules, road conditions, pedestrians, and the positions of other mobile bodies 500.

In the example illustrated in FIG. 1, the table D10 has a plurality of parameters obtained by combining the items of traffic controls, road surfaces and pedestrians and targets to which the parameters are applied. The targets to which the parameters are applied include, for example, cameras, LiDAR (Light Detection and Ranging, Laser Imaging Detection and Ranging) and radars. In Table D10, the items corresponding to the dynamic factors and the objects to which the parameters are applied do not have to be associated in a one to one relation. For example, the table D10 may be configured to associate the cameras with the road surfaces and the pedestrians without associating the cameras with the traffic controls. In FIG. 1, the details of the table D10 parameters are omitted. An example of the table D10 parameters is explained later.

The second server 200B is, for example, a Cloud server and is a server device that exchanges various information with the information processing device 100. The second server 200B is a device provided outside the mobile body 500. The second server 200B has, for example, a function of managing a dynamic map D100. The second server 200B has, for example, a function of providing information and the like of the dynamic map D100 to the information processing device 100. The second server 200B is a server device and is an example of the providing device.

As illustrated in FIG. 2, the dynamic map D100 is a database-like map in which vehicles and various kinds of traffic information are added to a three-dimensional map, and in which information is classified according to update frequencies of the information. The dynamic map D100 has three-dimensional geospatial information D110 and additional information D120 capable of supporting automatic traveling of a vehicle. The geospatial information D110 and the additional information D120 are associated with each other. Information that changes in situations at every moment can be utilized in real time.

The geospatial information D110 includes highly accurate information capable of specifying the position of an own vehicle relating to a road and the periphery of the road at a lane level. The geospatial information D110 is spatial map information that records various kinds of information such as lanes, guardrails, road signs, pedestrian crossings, and highways in accurate positions. The geospatial information D110 is static information in which various kinds of information such as roads, structures on the roads, lanes, road surfaces, and permanent regulations are updated within one month.

The additional information D120 has quasi-static information D121, quasi-dynamic information D122, and dynamic information D123. The quasi-static information D121 includes, for example, traffic control information, road construction information, wide area weather information, and the like, and is information that is updated within one hour. The quasi-dynamic information D122 is information including, for example, accident information, traffic congestion information, and narrow area weather at observation points and is information that is updated within one minute. The dynamic information D123 includes, for example, ITS (Intelligent Transport Systems) look-ahead information and is updated within 1 second. The look-ahead information includes, for example, distant information that cannot be detected by a vehicle. The dynamic information D123 includes, for example, information transmitted/exchanged among mobile bodies, signal display information, pedestrian information in intersections, bicycle information in intersections, and straight-ahead vehicle information in intersections.

In the present embodiment, the geospatial information D110 and the quasi-static information D121 are explained as an example of static information. The quasi-dynamic information D122 and the dynamic information D123 are explained as an example of the dynamic information.

Referring back to FIG. 1, the first server 200A communicates with the information processing device 100 to exchange information. The first server 200A transmits the parameter information D1 to the information processing device 100, for example, when the set timing and the parameter information D1 are updated. For example, when the parameter information D1 is updated, the first server 200A may transmit the change information indicating a difference from the parameter information D1 before the change to the information processing device 100.

The second server 200B communicates with the information processing device 100 to exchange information. The second server 200B provides, for example, the information of the dynamic map D100 to the information processing device 100 at a predetermined timing. The predetermined timing includes, for example, preset time and an update of the dynamic map D100.

The information processing device 100 sets parameters necessary for the movement of the mobile body 500 based on the parameter information D1. As a result, the mobile body 500 controls driving equipment, sensors, and the like with the set parameters to perform a moving operation. Further, the information processing device 100 has a function of changing parameters used for detection of the surrounding environment of the mobile body 500 based on the dynamic map D100 acquired from the second server 200B and the parameter information D1 of the mobile body 500.

Note that, in the present embodiment, a case where the information processing system 1 provides information to the information processing device 100 using the first server 200A and the second server 200B is explained. However, the present disclosure is not limited to this. For example, the information processing system 1 may realize the two first and second servers 200A and 200B with one server device.

[Configuration Example of Information Processing System According to First Embodiment]

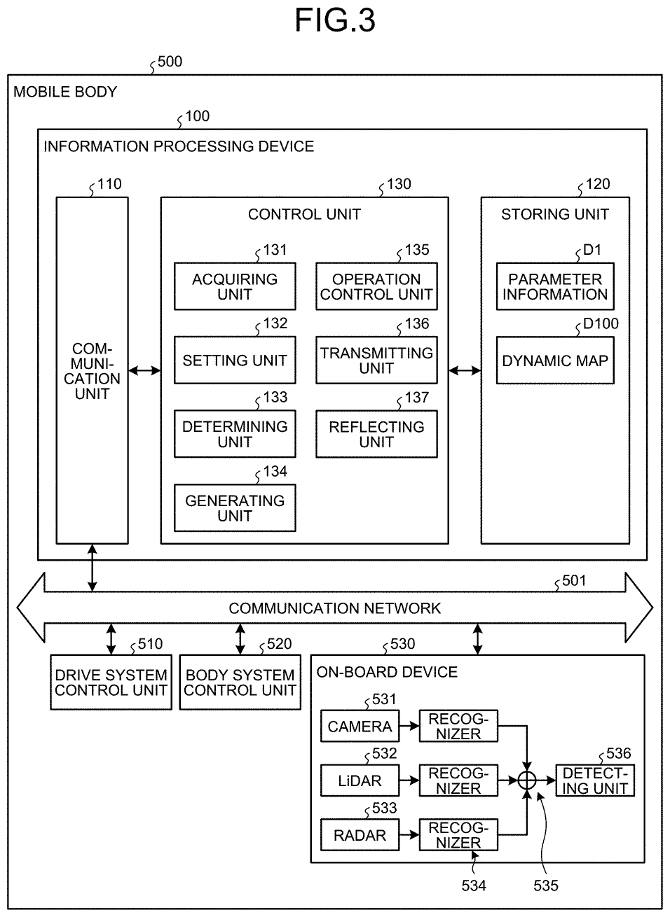

Subsequently, an example of the configuration of the information processing system 1 according to the first embodiment is explained. FIG. 3 is a configuration diagram illustrating an example of the configuration of the mobile body 500 and the information processing device 100 according to the first embodiment.

As illustrated in FIG. 3, the mobile body 500 includes a plurality of electronic control units connected via a communication network 501. The communication network 501 consists of, for example, a vehicle mounted communication network or bus conforming to any standard such as CAN (Controller Area Network), LIN (Local Interconnect Network), LAN (Local Area Network), or FlexRay (registered trademark). Note that, units of the mobile body 500 are sometimes directly connected not via the communication network 501. The direct connecting configuration includes a configuration connected by D2D (Device to Device) communication.

In the example illustrated in FIG. 3, the mobile body 500 includes a drive system control unit 510, a body system control unit 520, an on-board device 530, and an information processing device 100. In the present embodiment, a case where the on-board device 530 and the information processing device 100 are connected via the communication network 501 is explained. However, the on-board device 530 and the information processing device 100 may be directly connected via, for example, an interface. In the present embodiment, a case where the mobile body 500 includes one on-board device 530 is explained. However, the mobile body 500 may include a plurality of on-board devices 530.

The drive system control unit 510 controls the operation of devices relating to a drive system of the mobile body 500 according to various programs. For example, the drive system control unit 510 functions as a control device for a driving force generating device for generating a driving force for the mobile body 500 such as an internal combustion engine or a driving motor, a driving force transmission mechanism for transmitting the driving force to wheels, a steering mechanism for adjusting a steering angle of the mobile body 500, and a braking device that generate a braking force for the mobile body 500.

The body system control unit 520 controls the operations of various devices equipped in a vehicle body according to various programs. For example, the body system control unit 520 functions as a control device for a keyless entry system, a smart key system, a power window device, or various lamps such as a head lamp, a back lamp, a brake lamp, a winker, or a fog lamp. In this case, radio waves transmitted from a portable device substituting for a key or signals of various switches can be input to the body system control unit 520. The body system control unit 520 receives the input of the radio waves or the signals and controls a vehicle door lock device, a power window device, a lamp, and the like. Further, the body system control unit 520 may control static or dynamic information displayed on a display device installed on the body.

The on-board device 530 detects information concerning the surrounding environment (outside world) of the mobile body 500. The on-board device 530 acquires environmental information indicating the surrounding environment of the mobile body 500. The on-board device 530 includes, for example, various sensors and an imaging device. The on-board device 530 can detect the environment in the periphery of the on-board device 530 as information concerning the outside world. The periphery of the on-board device 530 indicates, for example, a region detectable by the on-board device 5630. The on-board device 530 can use, for example, at least one of a camera, a distance sensor, an acceleration sensor, a gyro sensor, a sound wave sensor, a position sensor, a temperature sensor, a humidity sensor, and an air pressure sensor. In addition, the on-board device 530 may detect a position using, for example, a GNSS (Global Navigation Satellite System) represented by a GPS (Global Positioning System), map matching, Wi-Fi (registered trademark) positioning, magnetic positioning, BLE (Bluetooth (registered trademark) Low Energy), or beacon positioning. The on-board device 530 supplies the detected information to the information processing device 100.

In the example illustrated in FIG. 3, a case where the on-board device 530 includes a camera 531 and a LiDAR (Light Detection and Ranging, Laser Imaging Detection and Ranging) 532, a radar 533, recognizers 534, a coupling unit 535, and a detecting unit 536 is explained. However, the on-board device 530 is not limited to this.

The camera 531 includes an imaging device such as a ToF (Time Of Flight) camera, a stereo camera, a monocular camera, an infrared camera, a Depth camera, and other cameras. The camera 531 is set such that parameters such as a setting direction, an angle of view, resolution, an exposure time, a sensor gain, and reflection cut setting (in the case of a polarization camera) can be changed. The LiDAR 532 measures, for example, scattered light with respect to laser irradiation emitted in a pulse shape and detects the distance to a target present at a long distance and characteristics of the target. The LiDAR 532 is set such that parameters such as a setting direction, horizontal resolution, vertical resolution, a measurement distance, and a laser output can be changed. The radar 533 detects an external object using, for example, an infrared rat, a millimeter wave, or ultrasonic wave. The radar 533 is set such that parameters such as angle of view, resolution, speed resolution, the number of antennas, a measurement distance, and multipath prevention can be changed. The camera 531, the LiDAR 532, and the radar 533 are examples of sensors. The camera 531, the LiDAR 532, and the radar 533 supply, for example, detection information indicating detection results detected based on the parameters to the respective recognizers 534.

The recognizers 534 recognize the detection results of the connected sensors and supply a recognition result to the coupling unit 535. The coupling unit 535 integrates recognition importance degrees indicated by parameters with the detection results of the sensors and supplies the recognition importance degrees to the detecting unit 536. For example, it is assumed that, when an event is traffic control, as the parameters, the importance degree of the camera 531 is “1”, the importance degree of the LiDAR 532 is “5”, and the importance degree of the radar 533 is “8”. In this case, the coupling unit 535 supplies a detection result with the importance degree of the detection result of the radar 533 set the highest to the detecting unit 536. The detecting unit 536 detects external information based on the supplied detection result and supplies detection information indicating the detection result to the information processing device 100 or the like via the communication network 501. As described above, the on-board device 530 can set the importance degrees of the detected information according to the parameters.

Note that, in the present embodiment, a case where the mobile body 500 includes one on-board device 530 is explained. However, the present disclosure is not limited to this. For example, the mobile body 500 may be configured to include a plurality of on-board devices 530. In addition, the coupling unit 535 may use machine learning to integrate the recognition results of the recognizers 534.

[Configuration Example of Information Processing Device According to First Embodiment]

Subsequently, an example of a functional configuration of the information processing device 100 according to the first embodiment is explained. As illustrated in FIG. 3, the information processing device 100 includes a communication unit 110, a storing unit 120, and a control unit 130. The control unit 130 is electrically connected to the communication unit 110 and the storing unit 120.

The communication unit 110 performs communication with in-vehicle equipment such as the on-board device 530 of the mobile body 500, various external electronic devices, the first server 200A, the second server 200B, a base station, and the like. The communication unit 110 outputs data received from the first server 200A to the control unit 130 and transmits data received from the control unit 130 to the first server 200A, the second server 200B, and the like. The communication unit 110 outputs the information included in the received data to the control unit 130 and transmits information included in the data received from the control unit 130 to the first server 200A, the second server 200B, and the like. The communication unit 110 outputs data received from the in-vehicle equipment to the control unit 130 and transmits the data received from the control unit 130 to relevant in-vehicle equipment. Note that a communication protocol supported by the communication unit 110 is not particularly limited. The communication unit 110 is capable of also supporting a plurality of types of communication protocols. Further, the communication unit 110 may support a plurality of types of wireless interfaces.

For example, the communication unit 110 performs wireless communication with the information processing device 100 or the like mounted on another mobile body 500 by wireless LAN, Bluetooth (registered trademark), NFC (Near Field Communication), WUSB (Wireless USB), or the like.

For example, the communication unit 110 performs communication with the first server 200A present on an external network (for example, the Internet, a Cloud network, or a network peculiar to a provider) via a base station or an access point. Further, for example, the communication unit 110 performs V2X communication such as vehicle-to-vehicle (V2V) communication, road-to-vehicle (V2I) communication, vehicle-to-network communication, vehicle-to-home communication, and pedestrian-to-vehicle (V2P) communication. That is, the communication unit 110 can perform, with the V2X communication, communication with the communication unit 110 mounted on another mobile body 500, an RSU (Road Side Unit), a base station or an access point, a wireless communication terminal (for example, a smartphone or a wearable device) carried by a pedestrian, a personal computers in a house, a tablet terminal, and the like. Further, for example, the communication unit 110 includes a beacon receiving unit, receives a radio wave or an electromagnetic wave transmitted from a radio station or the like set on a road, and acquires information such as the present position, traffic congestion, traffic control, and a required time.

The storing unit 120 stores various data and programs. The storing unit 120 is, for example a semiconductor memory such as a RAM (Random Access Memory) or a flash memory, a hard disk, or an optical disk. The storing unit 120 stores information received via the communication unit 110. The storing unit 120 stores various information such as parameter information D1 and a dynamic map D100. The storing unit 120 stores, for example, the parameter information D1 received from the first server 200A. The storing unit 120 stores, for example, a part or all of information of the dynamic map D100 received from the second server 200B.

The control unit 130 is, for example, a dedicated or general-purpose computer. The control unit 130 is, for example, an integrated control unit that controls the mobile body 500. The control unit 130 can calculate a control target value of the driving force generating device, the steering mechanism, or the braking device based on information inside and outside the vehicle detected by the on-board device 530 and output control information indicating a control command to the drive system control unit 510. For example, the control unit 130 can perform coordinated control for the purpose of function realization of an ADAS (Advanced Driver Assistance System) including collision avoidance or impact reduction of the mobile body 500, following traveling based on a vehicle-to-vehicle distance, vehicle speed maintenance traveling, a vehicle collision warning, or a vehicle lane deviation warning.

The control unit 130 controls the driving force generating device, the steering mechanism, the braking device, or the like based on information in the periphery of the mobile body 500 (the outside world) detected by the on-board device 530. Consequently, the control unit 130 can perform coordinated control for the purpose of automatic driving or the like for autonomously traveling without depending on operation of a driver.

The control unit 130 can output control information to the body system control unit 520 based on the information outside the vehicle detected by the on-board device 530. For example, the control unit 130 can perform coordinated control for the purpose of controlling headlamps according to the position of a preceding vehicle or an oncoming vehicle detected by the on-board device 530 and achieving glare prevention for, for example, switching a high beam to a low beam.

The control unit 130 includes an acquiring unit 131, a setting unit 132, a determining unit 133, a generating unit 134, an operation control unit 135, a transmitting unit 136, and a reflecting unit 137. The functional units of the acquiring unit 131, the setting unit 132, the determining unit 133, the generating unit 134, the operation control unit 135, the transmitting unit 136, and the reflecting unit 137 are realized by a program stored on the inside of the information processing device 100 being executed with a RAM or the like as a work area by a CPU (Central Processing Unit), an MPU (Micro Processing Unit), or the like. Further, the functional units may be realized by an integrated circuit such as an ASIC (Application Specific Integrated Circuit) or an FPGA (Field-Programmable Gate Array).

The acquiring unit 131 acquires various kinds of information via the communication unit 110 and stores the acquired information in the storing unit 120. The acquiring unit 131 acquires, for example, the parameter information D1 provided by the first server 200A and stores the parameter information D1 in the storing unit 120. The acquiring unit 131 acquires, for example, the dynamic map D100 from the second server 200B and stores the dynamic map D100 in the storing unit 120. The acquiring unit 131 may request the first server 200A to provide the parameter information D1 and acquire the parameter information D1. The acquiring unit 131 supplies the acquired information to the setting unit 132 and the like.

The setting unit 132 sets parameters used for detection of the surrounding environment of the mobile body 500 based on the dynamic information detected outside the mobile body 500 and the parameter information D1. That is, the setting unit 132 sets to dynamically change parameters used for detection of the surrounding environment of the mobile body 500 based on the dynamic information detected outside the mobile body 500 and the parameter information D1. Dynamically setting parameters means, for example, switching and setting a plurality of parameters. The parameters used for the detection of the surrounding environment of the mobile body 500 are, for example, parameters used by the mobile body 500, the on-board device 530, and the like when detecting the surrounding environment of the mobile body 500. The parameters used for the detection of the surrounding environment of the mobile body 500 are parameters that can be changed according to a state of the mobile body 500, a situation detected outside, and the like. The parameters used for the detection of the surrounding environment of the mobile body 500 include, for example, parameters used in various sensors, electronic equipment, and the like of the on-board device 530. In the present embodiment, for simplification of explanation, a case where targets for which the parameters are set is the camera 531, the LiDAR 532, and the radar 533 of the on-board device 530 is explained.

The setting unit 132 dynamically changes the parameters used for the detection of the surrounding environment of the mobile body 500 based on the dynamic information acquired by the acquiring unit 131. The setting unit 132 dynamically changes the parameters used for the detection of the surrounding environment of the mobile body 500 based on at least one of the quasi-dynamic information D122 and the dynamic information D123 of the dynamic map D100 acquired by the acquiring unit 131. As a result, the setting unit 132 can change the parameters to parameters suitable for detecting the surrounding environment based on, for example, ITS look-ahead information, accident information, traffic jam information, boundary weather information, and the like.

The setting unit 132 dynamically changes the parameters used for the detection of the surrounding environment of the mobile body 500 based on the static information of the dynamic map D100 acquired by the acquiring unit 131. The setting unit 132 dynamically changes the parameters used for the detection of the surrounding environment of the mobile body 500 based on, for example, at least one of the geospatial information D110 and the quasi-static information D121 of the dynamic map D100. Consequently, the setting unit 132 can change the parameters to parameters suitable for detecting the surrounding environment based on, for example, road surface information, lane information, three-dimensional structure information, traffic control information, road construction information, wide area weather information, and the like.

The setting unit 132 changes the parameter information D1 based on a risk degree determined by the determining unit 133. For example, the setting unit 132 changes the parameters, importance degrees, and the like of the parameter information D1 set when the risk degree is high. For example, the parameter information D1 includes the importance degrees. The importance degrees indicate, for example, importance degrees of a target, a parameter, and the like corresponding to an item. The importance degree can indicate, for example, importance degrees used in movement control of the mobile body 500 among the importance degrees of the camera 531, the LiDAR 532, and the radar 533 of the on-board device 530. In this case, the setting unit 132 dynamically changes the importance degrees of the recognition result of the on-board device 530 based on at least one of dynamic information and static information. An example of a method of changing importance degrees is explained later. Further, the setting unit 132 may change the parameters of the parameter information D1 using, for example, a change table, a result of machine learning, or the like.

The determining unit 133 determines a risk degree of the mobile body 500 based on a detection result of the detecting unit 536 of the on-board device 530. The determining unit 133 determines a risk degree of the mobile body 500, for example, based on a predicted damage value and an importance degree of the mobile body 500. The risk degree determined by the determining unit 133 can be indicated by Expression (1).

Risk degree=Σ(predicted damage value)×(importance degree) Expression (1)

The determining unit 133 supplies a determination result to the setting unit 132, the generating unit 134, and the like. The determination result of the determining unit 133 can be used for schemes such as emergency stop and avoidance of the mobile body 500 when the risk degree is a certain level or higher. The determining unit 133 can use the risk degree for route planning of an operation module by outputting the risk degree as a continuous value.

The generating unit 134 generates control information for controlling the mobile body 500 based on the determination result of the determining unit 133. That is, the generating unit 134 creates control information for controlling the movement of the mobile body 500 based on a detection result of the on-board device 530 based on the parameters. The generating unit 134 has a function of planning, for example, a route plan, an action plan, an operation plan, and the like. As the route plan, the generating unit 134 plans, for example, a route to a target value of the mobile body 500. As the action plan, the generating unit 134 plans, for example, an action of the mobile body 500 for safely traveling on the planned route within a planned time. Specifically, the generating unit 134 plans, for example, start, stop, a traveling direction (for example, forward, backward, left turn, right turn, and direction change), a traveling lane, traveling speed, and overtaking. As the operation plan, the generating unit 134 plans, for example, an operation of the mobile body 500 for realizing the planned action. Specifically, the generating unit 134 plans, for example, acceleration, deceleration, and a traveling track of the mobile body 500. The generating unit 134 plans an operation of the mobile body 500 for avoiding an emergency situation such as a sudden stop or a sharp turn based on the determination result of the risk degree. Then, when the generating unit 134 generates control information based on the plan, the generating unit 134 supplies the control information to the operation control unit 135.

The operation control unit 135 controls the operation of the mobile body 500 based on the control information (plan) of the generating unit 134. The operation control unit 135 controls the drive system control unit 510 based on the control information. For example, the operation control unit 135 performs control of the mobile body 500 realizing the control information of the generating unit 134. Then, the operation control unit 135 transmits an operation command or the like for driving the mobile body 500 to the drive system control unit 510. As a result, the mobile body 500 moves with a driving force generated by the control of the drive system control unit 510.

The transmitting unit 136 transmits change information obtained by changing the parameter information D1 based on the risk degree to the outside of the mobile body 500. The change information includes, for example, difference information of the parameter information D1 before and after the change and the parameter information D1 after the change. For example, the transmitting unit 136 transmits the change information to transmission destinations such as the mobile body 500 and the first server 200A in the periphery via the communication unit 110. For example, when the change information is generated, the transmitting unit 136 transmits the change information to the transmission destinations at timing such as periodic.

The reflecting unit 137 reflects the parameter information D1 transmitted by another mobile body 500 on the parameter information D1 stored in the storing unit 120. The reflecting unit 137 reflects the parameter information D1 changed on the outside of the mobile body 500 on the parameter information D1 of the own device. The reflecting unit 137 reflects the parameter information D1 provided by the first server 200A on the parameter information stored in the storing unit 120, for example, based on an update frequency of the parameter information D1 stored in the storing unit 120. An example of a method of reflecting the parameter information D1 is explained below.

The functional configuration example of the information processing device 100 according to the first embodiment is explained above. The configuration explained above with reference to FIG. 3 is only an example. The functional configuration of the information processing device 100 according to the first embodiment is not limited to such an example. The functional configuration of the information processing device 100 according to the first embodiment can be flexibly modified according to specifications and operations.

[Configuration Example of First Server According to First Embodiment]

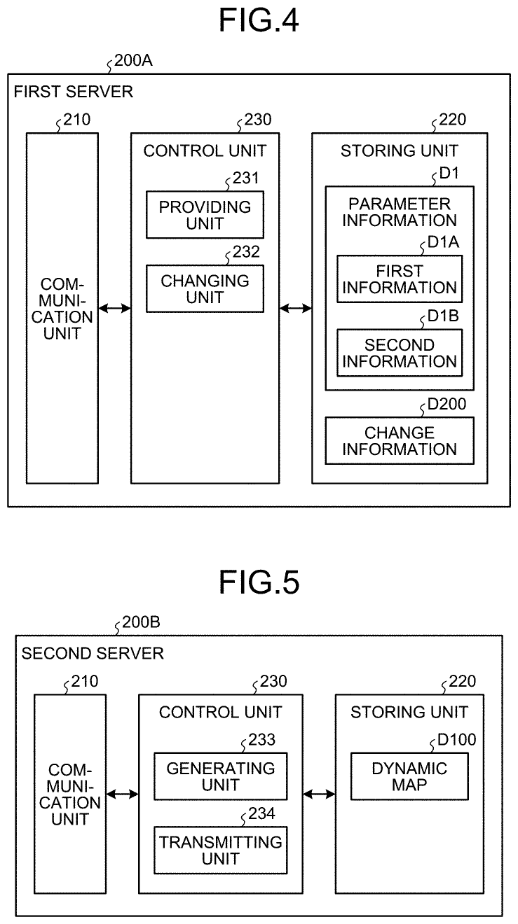

FIG. 4 is a configuration diagram illustrating an example of the configuration of the first server 200A according to the first embodiment. As illustrated in FIG. 4, the first server 200A includes a communication unit 210, a storing unit 220, and a control unit 230. The control unit 230 is electrically connected to the communication unit 210 and the storing unit 220.

The communication unit 210 has a function of supporting the communication protocol explained above and performing communication with the information processing device 100 of the mobile body 500, the base station, the server device, and the like. The communication unit 210 outputs data received from the information processing device 100 to the control unit 230 and transmits data received from the control unit 230 to the information processing device 100.

The storing unit 220 is realized by, for example, a semiconductor memory element such as RAM or flash memory or a storage device such as a hard disk or an optical disk. The storing unit 220 stores various kinds of information such as the parameter information D1 and change information D200 provided to a plurality of information processing devices 100. For example, the parameter information D1 of the storing unit 220 includes first information D1A for each vehicle type and second information D1B for each preference. The first information D1A includes information such as a parameter table corresponding to items corresponding to vehicle types and targets. The second information D1B includes information such as a parameter table corresponding to items corresponding to a preference and targets. The reference includes elements such as a traveling distance, a traveling time, average speed, and a frequency of gaining of automatic control by the driver. The change information D200 is information received from the information processing device 100 of the mobile body 500. The change information D200 is information capable of specifying changed content of a change of the parameter information D1 by the information processing device 100.

The control unit 230 controls the operation of the first server 200A. The control unit 230 includes a providing unit 231 and a changing unit 232. The functional units of the providing unit 231 and the changing unit 232 are realized by, for example, the control unit 230 executing a program stored in the control unit 230 using a RAM or the like as a work area.

The providing unit 231 provides the parameter information D1 concerning the parameters used for the detection of the surrounding environment of the mobile body 500 to the mobile body 500 via the communication unit 210 based on at least one of a type and driving preference of the mobile body 500. The providing unit 231 has a function of providing the parameter information D1 in response to a request from the information processing device 100 (the mobile body 500). The providing unit 231 has a function of providing the parameter information D1 after a change when the parameter information D1 is changed.

The changing unit 232 changes the parameter information D1 provided to the information processing device 100 based on change information of the information processing device 100. The changing unit 232 stores change information of a plurality of mobile bodies 500 in the storing unit 220 and periodically changes the parameter information D1 based on the change information. “Periodically” includes, for example, every weekend, every set time, and every vehicle inspection time. For example, when a risk degree equal to or higher than a threshold set in the mobile body 500 is determined, the changing unit 232 changes the parameter information D1 based on change information of the mobile body 500.

The functional configuration example of the first server 200A according to the first embodiment is explained above. The configuration explained above with reference to FIG. 4 is only an example. The functional configuration of the first server 200A according to the first embodiment is not limited to such an example. The functional configuration of the first server 200A according to the first embodiment can be flexibly modified according to specifications and operations.

[Configuration Example of Second Server According to First Embodiment]

FIG. 5 is a configuration diagram illustrating an example of the configuration of the second server 200B according to the first embodiment. As illustrated in FIG. 5, like the first server 200A, the second server 200B includes a communication unit 210, a storing unit 220, and a control unit 230.

The storing unit 220 stores, for example, a dynamic map 300 provided to the information processing device 100, the first server 200A, and the like.

The control unit 230 controls the operation of the second server 200B. The control unit 230 includes a generating unit 233 and a transmitting unit 234. The functional units of the generating unit 233 and the transmitting unit 234 are realized by, for example, the control unit 230 executing a program stored in the control unit 230 using a RAM or the like as a work area.

The generating unit 233 generates a real-time dynamic map D100. The generating unit 233 generates (updates) additional information D120 based on, for example, traffic information and traffic control information received via the communication unit 210 and associates the additional information D120 and the geospatial information D110 to generate the latest dynamic map D100. The generating unit 233 stores the generated dynamic map D100 in the storing unit 220.

The transmitting unit 234 transmits the dynamic map D100 to the information processing device 100 or the like via the communication unit 210. The transmitting unit 234 transmits, for example, the dynamic map D100 generated or updated by the generating unit 233 to the information processing device 100 and the like. The transmitting unit 234 may, for example, broadcast the dynamic map D100 on a network.

The functional configuration example of the second server 200B according to the first embodiment is explained above. The configuration explained above with reference to FIG. 5 is only an example. The functional configuration of the second server 200B according to the first embodiment is not limited to such an example. The functional configuration of the second server 200B according to the first embodiment can be flexibly modified according to specifications and operations.

[Example of Parameter Information According to First Embodiment]

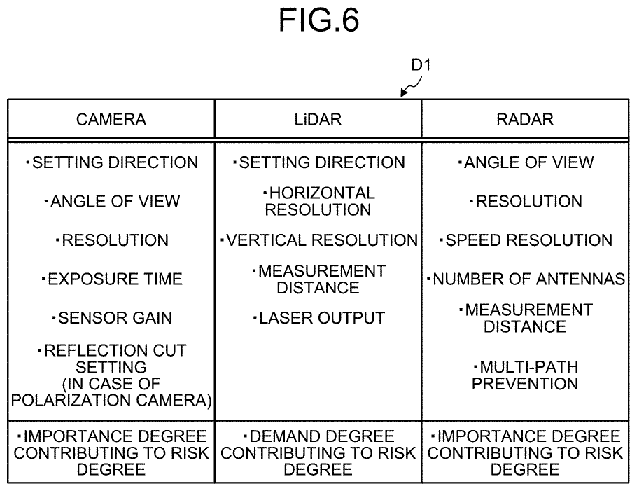

FIG. 6 is a diagram illustrating an example of the parameters of the parameter information D1 according to the first embodiment. The parameter information D1 illustrated in FIG. 6 shows an example of parameters of the camera 531, the LiDAR 532, and the radar 533 of the on-board device 530. The parameter information D1 indicates that control target parameters of the camera 531 are, for example, a setting direction, an angle of view, resolution, an exposure time, a sensor gain, and reflection cut setting (in the case of a polarization camera). The parameter information D1 indicates that control target parameters of LiDAR 532 are, for example, a setting direction, horizontal resolution, vertical resolution, a measurement distance, and a laser output. The parameter information D1 indicates that control target parameters of the radar 533 are, for example, an angle of view, resolution, speed resolution, the number of antennas, a measurement distance, and multipath prevention. The parameter information D1 indicates respective importance degrees of the camera 531, the LiDAR 532, and the radar 533 contributing to a risk degree of the mobile body 500.

The parameter information D1 can set parameters for control target electronic devices, sensors, and the like. For example, in the case of a microphone, the parameter information D1 may be configured to indicate an importance degree of the microphone with parameters such as a setting direction and an effective frequency band set as control targets.

[Example of Table According to First Embodiment]

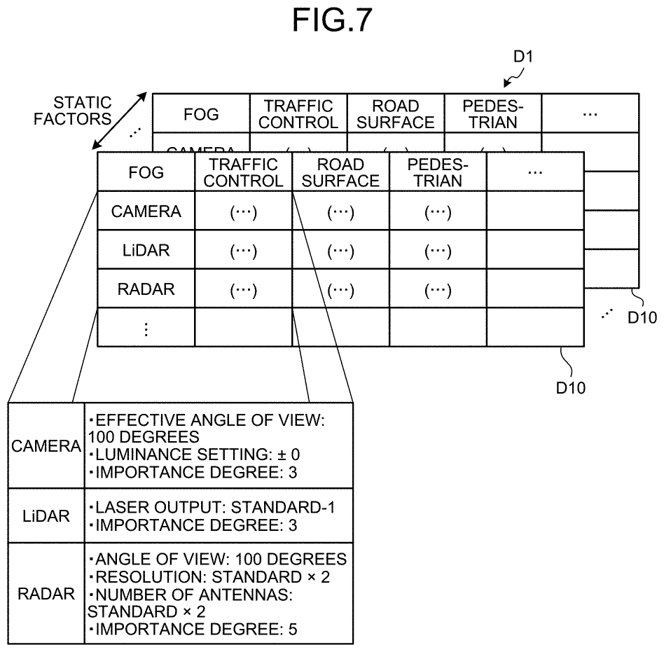

FIG. 7 is a diagram illustrating an example of the table D10 of the parameter information D1 according to the first embodiment. Note that, in FIG. 7, the table D10 shows a part of the parameters for simplification of explanation.

As illustrated in FIG. 7, the parameter information D1 has the table D10 in which a static factor corresponds to “fog”. For example, when a surrounding environment is fog, since it is difficult for the camera 531 and LiDAR 532 to sense the mobile body 500, the importance degrees of the camera 531 and the LiDAR 532 are relatively reduced and the importance degree of the radar 533 is increased. Consequently, the mobile body 500 can perform detection of the surrounding environment mainly by the radar 533. For example, at the time of traffic control, it is necessary to pay attention to a relatively short distance of the mobile body 500. For this reason, about items of traffic control, the parameter information D1 is set such that an effective angle of view of the camera 531 is set wider and a laser output of the LiDAR 532 is lower than a standard.

In the example illustrated in FIG. 7, the table D10 shows the parameters and importance degree of the camera 531, the LiDAR 532, and the radar 533, items of which correspond to the traffic control. As the parameters of the camera 531, an effective angle of view is set to “100 degrees” and brightness setting is set to “±0”. An importance degree of the camera is set to a value of “3”. As the parameter of LiDAR 532, a laser output is set to “Standard-1”. An importance degree of the LiDAR 532 is set to a value of “3”. As the parameters of the radar 533, an angle of view is set to “100 degrees”, resolution is set to “standard×2”, and the number of antennas is set to “standard×2”. An importance degree of the radar 533 is set to a value of “5”.

In the present embodiment, the table D10 of the parameter information D1 has the parameters and the importance degrees. However, the present disclosure is not limited to this. For example, when the table D10 is applied to machine learning, coefficients and the like for the machine learning may be included in the table D10.

[Processing Procedure of Information Processing System According to First Embodiment]

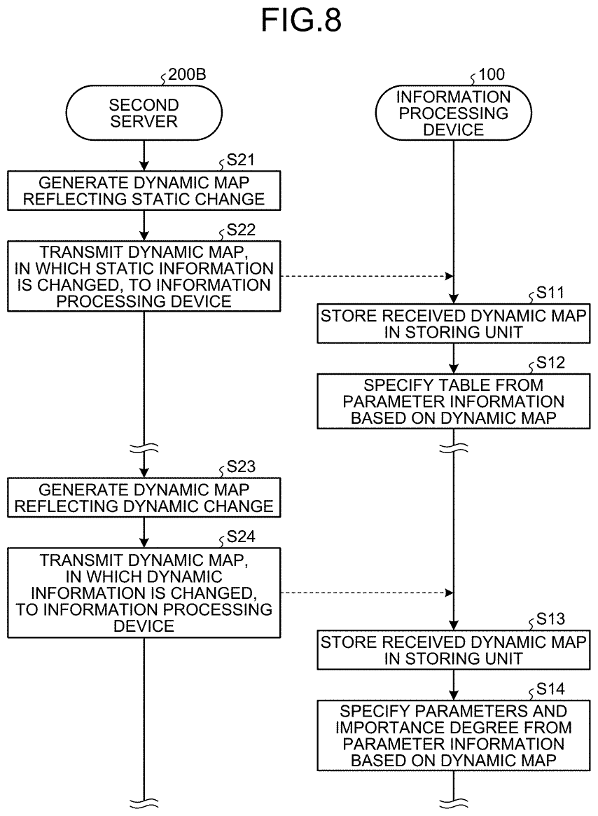

Subsequently, a processing procedure of the information processing system 1 according to the first embodiment is explained with reference to FIG. 8. FIG. 8 is a sequence chart illustrating an example of the processing procedure of the information processing system 1 according to the first embodiment. The processing procedure illustrated in FIG. 8 is realized by the control unit 130 of the information processing device 100 and the control unit 230 of the second server 200B executing a program.

As illustrated in FIG. 8, the second server 200B generates the dynamic map D100 that reflects a static change (step S21). For example, the second server 200B generates, based on road surface information, lane information, weather information, and the like received via the communication unit 210, the dynamic map D100 that reflects a static change. The second server 200B transmits the dynamic map D100, static information of which is changed, to the information processing device 100 (step S22). For example, the second server 200B transmits a part or all of the information of the dynamic map 300 to each of the plurality of information processing devices 100 via the communication unit 210.

The information processing device 100 stores the dynamic map 300 received from the second server 200B via the communication unit 110 in the storing unit 120 (step S11). The information processing device 100 specifies the table D10 from the parameter information D1 based on the dynamic map D100 (step S12). For example, the information processing device 100 specifies the table D10 corresponding to a static factor indicated by the dynamic map D100.

Thereafter, the second server 200B generates the dynamic map D100 that reflects a dynamic change (step S23). For example, the second server 200B generates, based on ITS look-ahead information, traffic control information, road construction information, accident information, and the like received via the communication unit 210, the dynamic map D100 in which a dynamic change is determined. The second server 200B transmits the dynamic map D100, the dynamic information of which is changed, to the information processing device 100 (step S24).

The information processing device 100 stores the dynamic map 300 received from the second server 200B via the communication unit 110 in the storing unit 120 (step S13). The information processing device 100 specifies parameters and an importance degree from the parameter information D1 based on the dynamic map D100 (step S14). For example, the information processing device 100 specifies parameters and an importance degree corresponding to a dynamic factor from the table D10 corresponding to a static factor indicated by the dynamic map D100.

In the present embodiment, a case where the information processing device 100 acquires the dynamic map D100 from the second server 200B is explained. However, the present disclosure is not limited to this. For example, the second server 200B may transmit the dynamic map D100 to the first server 200A. The first server 200A may transmit the dynamic map D100 to the information processing device 100.

[Parameter Changing Procedure Example of Information Processing Device According to First Embodiment]

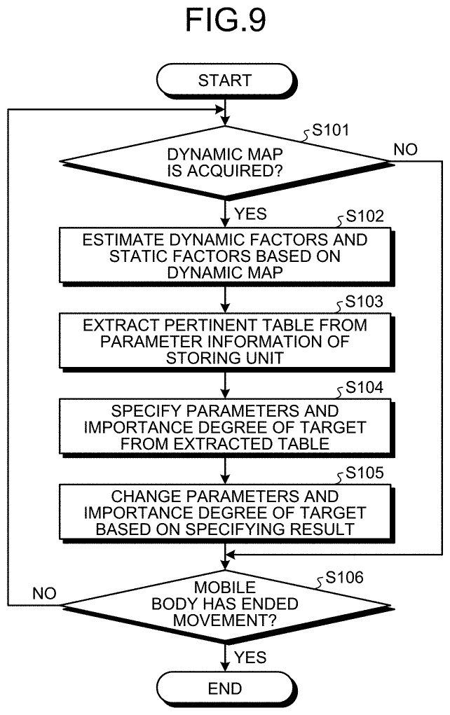

FIG. 9 is a flowchart illustrating an example of a processing procedure for changing parameters of the information processing device according to the first embodiment. The processing procedure illustrated in FIG. 9 is realized by the control unit 130 of the information processing device 100 executing a program. The processing procedure illustrated in FIG. 9 is executed by the control unit 130, for example, according to a start of movement of the mobile body 500.

As illustrated in FIG. 9, the control unit 130 of the information processing device 100 determines whether the dynamic map D100 is acquired (step S101). For example, the control unit 130 determines that the dynamic map D100 is acquired when the dynamic map D100 is received from the second server 200B via the communication unit 110. When determining that the dynamic map D100 is acquired (No in step S101), the control unit 130 advances the processing to step S106 explained below. When determining that the dynamic map D100 is acquired (Yes in step S101), the control unit 130 advances the processing to step S102.

The control unit 130 estimates a dynamic factor and a static factor based on the dynamic map D100 (step S102). For example, the control unit 130 estimates a dynamic factor and a static factor based on the three-dimensional geospatial information D110 of the dynamic map D100 and the additional information D120 capable of supporting automatic traveling of the mobile body 500. When the control unit 130 stores an estimation result in the storing unit 120, the control unit 130 advances the processing to step S103.

The control unit 130 extracts a relevant table from the parameter information D1 of the storing unit 120 (step S103). For example, the control unit 130 extracts the table D10 corresponding to the static factor estimated in step S102 from the parameter information D1. For example, when the static factor is fog, the control unit 130 extracts the table D10 corresponding to the fog from the parameter information D1. When the processing in step S103 ends, the control unit 130 advances the processing to step S104.

The control unit 130 specifies parameters and an importance degree of a target from the extracted table D10 (step S104). For example, the control unit 130 specifies parameters and an importance degree of the target in the table D10 according to a relation between an item corresponding to the dynamic factor estimated in step S102 and the target. When the processing in step S104 ends, the control unit 130 advances the processing to step S105.

The control unit 130 changes the parameters and the importance degree of the target based on a specifying result (step S105). For example, when the target is electronic equipment of the on-board device 530, the control unit 130 requests, via the communication unit 110, the on-board device 530 to change at least one of the parameters and the importance degree of the target. For example, when the target is the drive system control unit 510, the control unit 130 requests, via the communication unit 110, the drive system control unit 510 to change at least one of the parameters and the importance degree. When the processing in step S105 ends, the control unit 130 advances the processing to step S106.

The control unit 130 determines whether the mobile body 500 has ended movement (step S106). For example, when the control unit 130 confirms based on a moving state, a movement plan, control information, a driving situation, and the like of the mobile body 500 that the movement of the mobile body 500 has ended, the control unit 130 determines that the mobile body 500 has ended the movement. When determining that the mobile body 500 has not ended the movement (No in step S106), the control unit 130 returns the processing to step S101 explained above and continues the processing. Further, when determining that the mobile body 500 has ended the movement (Yes in step S106), the control unit 130 ends the processing procedure illustrated in FIG. 9

In the processing procedure illustrated in FIG. 9, a case where the control unit 130 performs the change of the parameters and the importance degree with the acquisition of the dynamic map D100 as a trigger tis explained. However, the present disclosure is not limited to this. For example, the control unit 130 may also set, as the trigger for performing the change of the parameters and the importance degree, for example, the on-board device 530 detecting a set event, state, or the like or the on-board device 530 acquiring change information from another mobile body 500.

[Example of Changing Parameters of Information Processing Device According to First Embodiment]

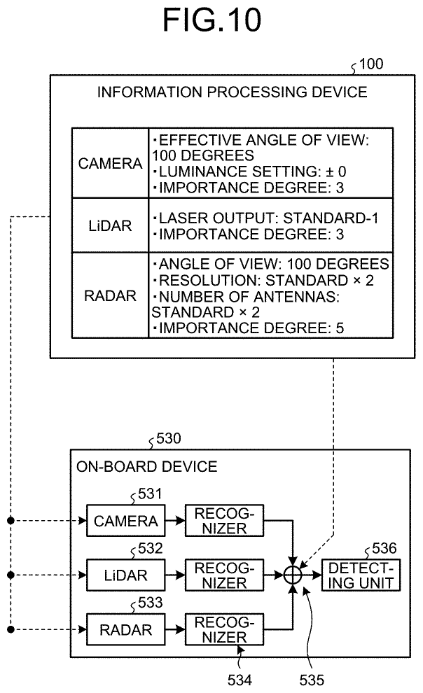

FIG. 10 is a diagram for explaining an example of changing parameters and an importance degree according to the first embodiment. In a scene illustrated in FIG. 10, in the on-board device 530 of the mobile body 500, parameters and importance degrees of the camera 531, the LiDAR 532, and the radar 533 corresponding to movement of the mobile body 500 are set by the information processing device 100. In this case, the on-board device 530 is based on the premise that the camera 531, the LiDAR 532, and the radar 533 detect external information of with the same degree of importance.

The information processing device 100 estimates that a static factor of the mobile body 500 is fog and a dynamic factor of the mobile body 500 is traffic control, for example, based on the dynamic map D100. The information processing device 100 extracts a table in which a static factor is fog from the parameter information D1 of the storing unit 120 and specifies parameters and an importance degree of an item corresponding to the dynamic factor. The information processing device 100 changes the parameters of the camera 531, the LiDAR 532, and the radar 533 of the on-board device 530 to the specified parameters. The information processing device 100 changes the importance degree of the coupling unit 535 of the on-board device 530 to the specified importance degree. As a result, in the on-board device 530, the camera 531, the LiDAR 532, and the radar 533 perform the detection operation with the changed parameters. The on-board device 530 combines the detection results of the camera 531, the LiDAR 532, and the radar 533 based on the importance degrees. The detecting unit 536 detects external information.

In the example illustrated in FIG. 10, in the on-board device 530, the importance degree of the radar 533 is set the highest. Therefore, a detection result is mainly obtained by the radar 533. In addition, at the time of traffic control, it is necessary to pay attention to a relatively short distance from the mobile body 500. Therefore, since the effective angle of view of the camera 531 is widened by the changed parameters, the on-board device 530 can effectively image an object or the like around the mobile body 500. The on-board device 530 supplies the detection result to the information processing device 100 and the like via the communication network 501.

[Example of Changing Importance Degree by Risk Degree Determination of Information Processing Device According to First Embodiment]

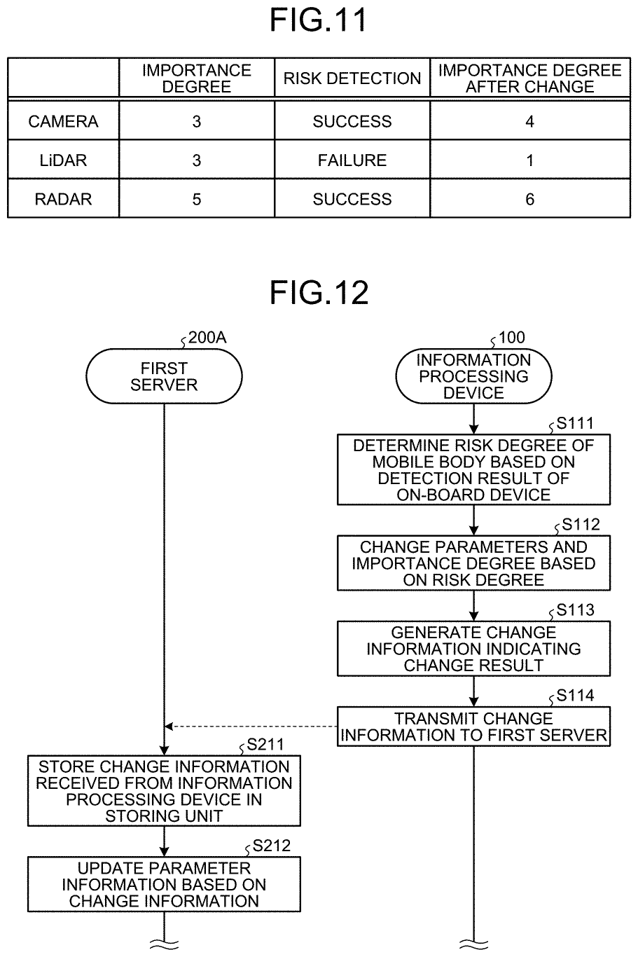

FIG. 11 is a diagram for explaining an example of changing an importance degree by risk degree determination of the information processing device 100 according to the first embodiment. In the example illustrated in FIG. 11, in the on-board device 530 of the mobile body 500, importance degrees of the camera 531, the LiDAR 532, and the radar 533 are set by the information processing device 100. The importance degrees of the camera 531 and LiDAR 532 are set to “3”. The importance degree of radar 533 is set to “5”.

The information processing device 100 determines a risk degree of the mobile body 500 with the determining unit 133 based on a detection result of the detecting unit 536 of the on-board device 530. The information processing device 100 specifies detection results of the camera 531, the LiDAR 532, and the radar 533 based on the detection result. In the example illustrated in FIG. 11, the information processing device 100 specifies that a risk is detected by the camera 531 and the radar 533 and is not detected by the LiDAR 532. In this case, the information processing device 100 increases the importance degree of the camera 531 from “3” to “4”, increases the importance degree of the radar 533 from “5” to “6”, and reduces the importance degree of the LiDAR 532 from “3” to “1”.

When the information processing device 100 detects a failure of the electronic equipment of the on-board device 530, the information processing device 100 may set an importance degree of the failed electronic equipment to “0” and may not use the electronic equipment for determination of a risk degree. Further, the information processing device 100 may perform a change of the importance degree based on a comparison result of external information received via the communication unit 110 and a determination result of a risk degree. Further, the information processing device 100 may change the parameters when the importance degree of the parameter information D1 is changed. For example, when the importance degree of the camera 531 is increased, the information processing device 100 may perform a change such as widening an effective angle of view of the parameter and increasing luminance setting.

[Example of Parameter Feedback According to First Embodiment]

Subsequently, an example of feedback of parameters of the information processing system 1 according to the first embodiment is explained with reference to FIG. 12. FIG. 12 is a sequence chart illustrating an example of feedback of the information processing system 1 according to the first embodiment. A processing procedure illustrated in FIG. 12 is realized by the control unit 130 of the information processing device 100 and the control unit 230 of the first server 200A executing a program.

As illustrated in FIG. 12, the information processing device 100 determines a risk degree of the mobile body 500 based on a detection result of the on-board device 530 (step S111). The information processing device 100 changes parameters and an importance degree based on the risk degree (step S112). For example, the information processing device 100 detects a suitability degree of the detection result of the on-board device 530 and customizes the parameters and the importance degree based on the suitability degree. For example, the information processing device 100 may detect the suitability degree of the detection result of the on-board device 530 based on the detection result of the on-board device 530 and a detection result of an external sensing device of the mobile body 500. The external sensing device includes various sensing devices of, for example, other mobile bodies 500 and an infrastructure. As a result, the generating unit 134 starts generating control information based on the parameters after the change. The operation control unit 135 controls the operation of the mobile body 500 based on the control information.

The information processing device 100 generates change information D200 indicating the change result (step S113). The information processing device 100 transmits the change information D200 to the first server 200A via the communication unit 110 (step S114). Note that, the timing at which the information processing device 100 transmits the change information D200 to the first server 200A includes, for example, periodic and a case where a set risk degree is determined.

The first server 200A stores the change information D200 received from the information processing device 100 via the communication unit 210 in the storing unit 220 (step S211). The first server 200A changes the parameter information D1 based on the change information D200 (step S212). For example, the first server 200A classifies the change information D200 under predetermined conditions, aggregates and generalizes the change information D200. The predetermined conditions include conditions such as a traveling distance, a traveling time, average speed, and a frequency of gaining of automatic control by the driver. The first server 200A changes the parameters, the importance degrees, and the like of the first information D1A and the second information D1B of the parameter information D1 based on an aggregation result. The first server 200A adds a new parameter to the parameter information D1 or deletes a parameter from the parameter information D1 based on the aggregation result or the like.

[Example of Reflecting Parameter Information of Information Processing Device According to First Embodiment]

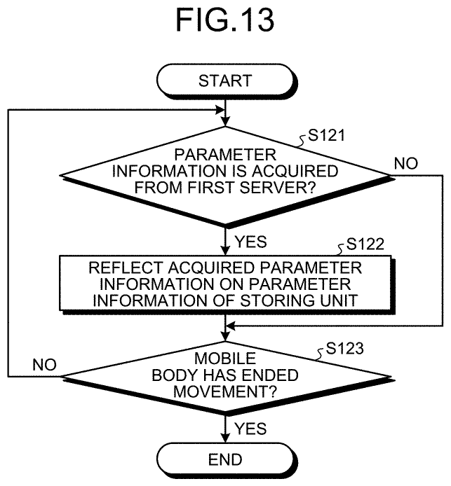

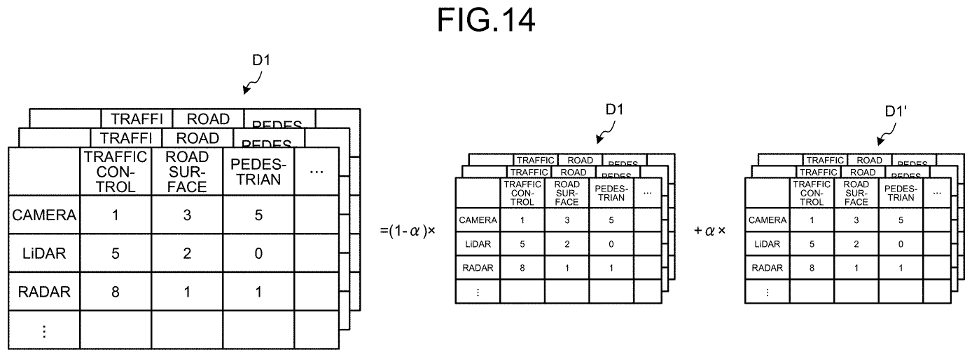

FIG. 13 is a flowchart illustrating an example of a processing procedure for reflecting the parameter information D1 of the information processing device 100 according to the first embodiment. FIG. 14 is a diagram for explaining an example of reflection of the parameter information D1. The processing procedure illustrated in FIG. 13 is realized by the control unit 130 of the information processing device 100 executing a program. The processing procedure illustrated in FIG. 13 is executed by the control unit 130, for example, during the operation of the information processing device 100.

As illustrated in FIG. 13, the control unit 130 of the information processing device 100 determines whether the parameter information D1 is acquired from the first server 200A (step S121). For example, when the parameter information D1 is received from the first server 200A via the communication unit 110, the control unit 130 determines that the parameter information D1 is acquired. When determining that the parameter information D1 is not acquired (No in step S121), the control unit 130 advances the processing to step S123 explained below. When determining that the parameter information D1 is acquired (Yes in step S121), the control unit 130 advances the processing to step S122.

The control unit 130 reflects the acquired parameter information D1 on the parameter information D1 of the storing unit 120 (step S122). For example, the control unit 130 reflects the parameter information D1 using a reflection rate a as illustrated in FIG. 14. When a value of the reflection rate a is 1, the reflection rate a means that the parameter information D1 is completely overwritten. When the reflection rate a is, for example, larger than 0 and equal to or smaller than 1, the reflection rate a means that the parameter information D1 is not overwritten. For example, in the case of the mobile body 500 of a person having a high driving frequency, by setting a high value as the reflection rate a, it is possible to reduce the possibility that a custom result or the like of the parameter information D1 is overwritten. The control unit 130 compares a result of multiplying the parameter information D1 before the change by (1-a) and a result of multiplying parameter information D1′ acquired from the first server 200A by the reflection rate a and updates the parameter information D1 according to the reflection rate. For example, when parameters before the change and parameters after the change are different, the control unit 130 determines whether to update the parameter information D1 according to the reflection rate a. The control unit 130 also changes an importance degree in the same manner.

Note that the reflection rate a may be set to a different value for each item in the table D10. Examples of an item for which the reflection rate a should be set rather high include an item in table D10 in which an update frequency of the information processing device 100 is low because information of the dynamic map D100 is not received often. Examples of an item for which the reflection rate a should be set rather high include an item having large deviation between the table D10 retained by the information processing device 100 and the table D10 received from the first server 200A. Referring back to FIG. 13, when the processing in step S122 ends, the control unit 130 advances the processing to step S123.

The control unit 130 determines whether the mobile body 500 has ended the movement (step S123). When determining that the mobile body 500 has not ended the movement (No in step S123), the control unit 130 returns the processing to step S121 explained above and continues the processing. Further, when determining that the mobile body 500 has ended the movement (Yes in step S123), the control unit 130 ends the processing procedure illustrated in FIG. 13.

As explained above, in the information processing system 1 according to the first embodiment, the information processing device 100 dynamically sets, based on the dynamic information detected outside the mobile body 500 and the parameter information D1 of the own device, the parameters used for the detection of the surrounding environment of the mobile body 500. Consequently, the information processing system 1 can achieve optimization of the parameters used for the detection of the surrounding environment of the mobile body 500 by setting the parameters corresponding to the external environment of the mobile body 500 with the information processing device 100 and can contribute to improvement of safety in the movement of the mobile body 500.

Note that the first embodiment explained above shows an example and various modifications and applications are possible. The information processing system 1 in the first embodiment may be applied to other embodiments and the like.

[Modification of First Embodiment]

In the first embodiment, the case where the information processing device 100 changes the parameter information D1 of the own device based on the parameter information D1 acquired from the first server 200A is explained. However, the present disclosure is not limited to this. For example, the information processing device 100 can change the parameter information D1 of the own device based on the parameter information D1, the change information D200, and the like acquired from another mobile body 500. In a modification of the first embodiment, an example in which the information processing device 100 changes the parameter information D1 of the own device based on the change information D200 acquired from another mobile body 500 is explained.

[Example of Reflecting Parameter Information of Information Processing Device According to Modification of First Embodiment]

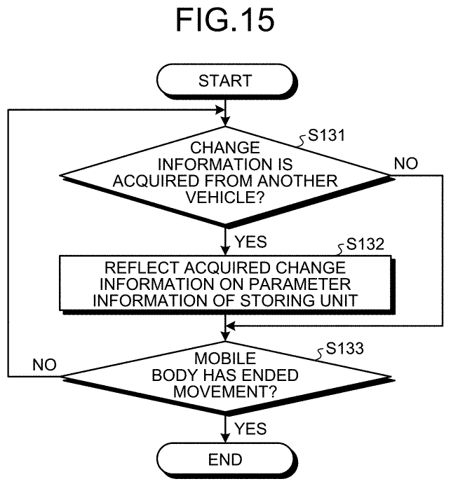

FIG. 15 is a flowchart illustrating an example of a processing procedure for reflecting the parameter information D1 of the information processing device 100 according to the modification of the first embodiment. The processing procedure illustrated in FIG. 15 is realized by the control unit 130 of the information processing device 100 executing a program. The processing procedure illustrated in FIG. 15 is executed by the control unit 130, for example, during the operation of the information processing device 100.

As illustrated in FIG. 15, the control unit 130 of the information processing device 100 determines whether the change information D200 is acquired from another mobile body 500 (step S131). For example, when the control unit 130 receives the change information D200 from another mobile body 500 and the information processing device 100 mounted on the mobile body 500 via the communication unit 110, the control unit 130 determines that the change information D200 is acquired. When determining that the change information D200 is not acquired (No in step S131), the control unit 130 advances the processing to step S133 explained below. When determining that the change information D200 is acquired (Yes in step S131), the control unit 130 advances the processing step S132.

The control unit 130 reflects the acquired change information D200 on the parameter information D1 of the storing unit 120 (step S132). For example, the control unit 130 changes, based on change conditions, parameters and an importance degree changed by the change information D200. The change conditions include, for example, conditions that update weight of parameters and an importance degree of a change target is lower than a threshold, a type of the mobile body 500 coincides, and preference of the parameter information D1 coincides. The control unit 130 changes at least one of the parameters and the importance degree satisfying the change conditions based on the change information D200. When the processing in step S132 ends, the control unit 130 advances the processing to step S133.

The control unit 130 determines whether the mobile body 500 has ended movement (step S133). When determining that the mobile body 500 has not ended the movement (No in step S133), the control unit 130 returns the processing to step S131 explained above and continues the processing. Further, when determining that the mobile body 500 has ended the movement (Yes in step S133), the control unit 130 ends the processing procedure illustrated in FIG. 15.

### Second Embodiment

[Configuration Example of Information Processing System According to Second Embodiment]

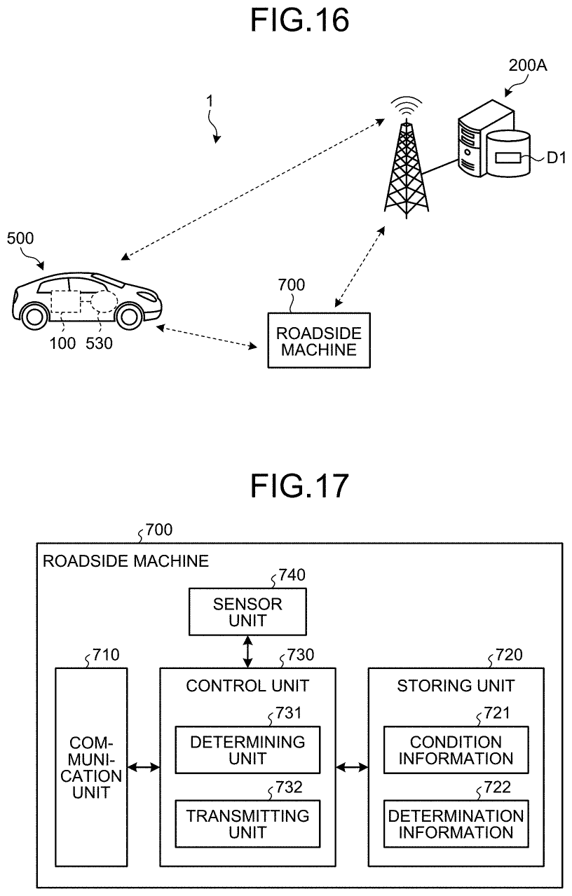

Subsequently, a second embodiment is explained. FIG. 16 is a diagram for explaining an example of realizing an information processing method according to the second embodiment. As illustrated in FIG. 16, the information processing system 1 includes the information processing device 100 mounted on the mobile body 500, the first server 200A that provides the parameter information D1, and a roadside machine 700. The information processing system 1 may include the second server 200B2 explained above in the configuration.

The roadside machine 700 is, for example, electronic equipment provided outside the mobile body 500 and capable of communicating with the mobile body 500. That is, the roadside machine 700 is an example of an external device provided outside the mobile body 500. The roadside machine 700 is provided as an infrastructure in, for example, a road, an intersection, a traffic light, a parking lot, or the like. For example, the roadside machine 700 has a configuration capable of exchanging various kinds of information with an unspecified number of mobile bodies 500 approaching the roadside machine 700.

A case where the information processing device 100 has the configuration of the information processing device 100 illustrated in FIG. 3 is explained. A case where the first server 200A has the configuration of the first server 200A illustrated in FIG. 4 is explained. That is, the information processing system 1 is a system in which the roadside machine 700 is added to the information processing system 1 according to the first embodiment.

[Configuration Example of Roadside Machine According to Second Embodiment]

FIG. 17 is a configuration diagram illustrating an example of the configuration of the roadside machine 700 according to the second embodiment. As illustrated in FIG. 17, the roadside machine 700 includes a communication unit 710, a storing unit 720, a control unit 730, and a sensor unit 740.

The communication unit 710 has a function of supporting the communication protocol explained above and communicating with, for example, the first server 200A, the information processing device 100 of the mobile body 500, and the base station. The communication unit 710 outputs data received from the information processing device 100 to the control unit 730 and transmits the data received from the control unit 730 to the information processing device 100. The communication unit 710 outputs data received from the first server 200A to the control unit 730 and transmits data received from the control unit 730 to the first server 200A.

The storing unit 720 is realized by, for example, a semiconductor memory element such as RAM or a flash memory or a storage device such as a hard disk or an optical disk. The storing unit 720 stores various kinds of information such as condition information 721 and determination information 722. The condition information 721 includes, for example, information indicating conditions for determining a risk degree of the mobile body 500. The determination information 722 includes, for example, information indicating a determination result of a risk degree of the roadside machine 700.

The control unit 730 is, for example, a dedicated or general-purpose computer. The control unit 730 controls the operation of the roadside machine 700. The control unit 730 includes a determining unit 731 and a transmitting unit 732. The functional units of the determining unit 731 and the transmitting unit 732 are realized by, for example, a CPU or an MPU executing a program stored inside the roadside machine 700 using a RAM or the like as a work area. Further, the functional units may be realized by an integrated circuit such as an ASIC or an FPGA.

The determining unit 731 has a function of determining a risk degree of the mobile body 500. The determining unit 731 determines a risk degree of the mobile body 500, for example, based on a detection result of the sensor unit 740. The determining unit 731 determines a risk degree of the mobile body 500 based on, for example, an image of the mobile body 500 captured by the imaging device, the speed of the mobile body 500 detected by the sensing device, and the like. The determining unit 731 generates determination information 722 indicating a determination result of the risk degree of the mobile body 500, correlates the determination information 722 with the mobile body 500, and stores the determination information 722 in the storing unit 720. Note that the determining unit 731 may determine a risk degree of the mobile body 500 based on the dynamic map D100 of the second server 200B. The determining unit 731 may acquire detection information from the mobile body 500 and determine a risk degree of the mobile body 500 based on the detection information.

The transmitting unit 732 transmits the determination information 722 generated by the determining unit 731 to the mobile body 500 via the communication unit 710. For example, the transmitting unit 732 may broadcast the determination information 722 via the communication unit 710 or may transmit the determination information 722 toward a specified mobile body 500.

The sensor unit 740 acquires environmental information indicating the surrounding environment of the own device. The sensor unit 740 includes various sensors such as a sensor for detecting an object such as a mobile body 500 and a human and a sensor for detecting a road surface condition. The sensor unit 740 detects the surrounding environment according to parameters that can be changed. The parameters include parameters such as a detection range, a sensor to be used, and the number of sensors. The sensor unit 740 acquires, for example, environmental information of a position where detection is difficult in the driver, the mobile body 500, or the like. The sensor unit 740 supplies, for example, environmental information indicating the surrounding environment of the own device to the control unit 730.

The functional configuration example of the roadside machine 700 according to the second embodiment is explained above. The configuration explained above with reference to FIG. 17 is only an example and the functional configuration of the roadside machine 700 according to the second embodiment is not limited to such an example. The functional configuration of the roadside machine 700 according to the second embodiment can be flexibly modified according to the specifications and operation.

[Example of Feedback of Parameters According to Second Embodiment]

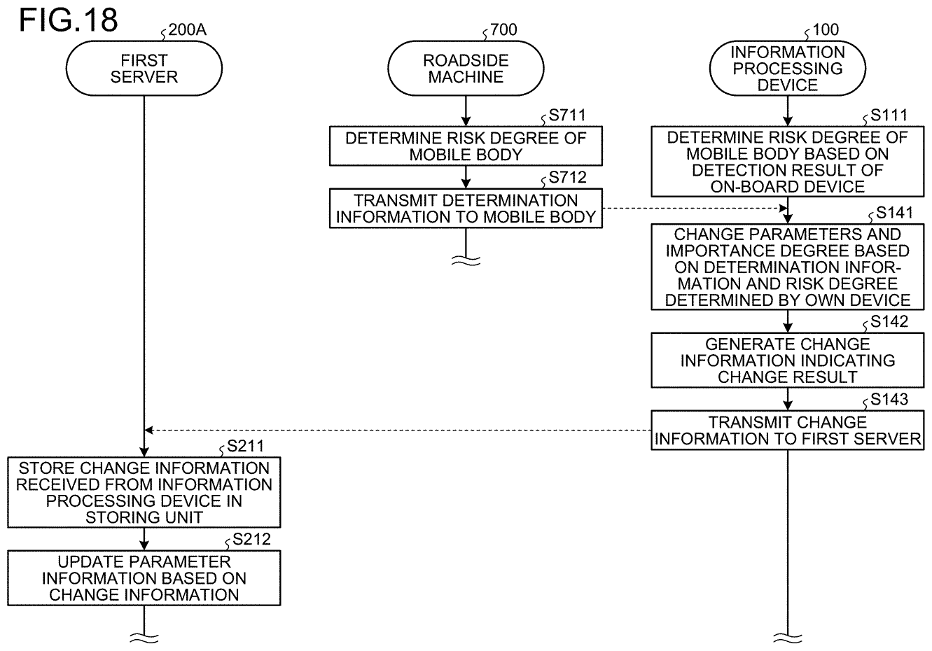

Subsequently, an example of feedback of parameters of the information processing system 1 according to the second embodiment is explained with reference to FIG. 18. FIG. 18 is a sequence chart illustrating an example of feedback of the information processing system 1 according to the second embodiment. A processing procedure illustrated in FIG. 18 is realized by the control unit 130 of the information processing device 100, the control unit 730 of the roadside machine 700, and the control unit 230 of the first server 200A executing a program.

As illustrated in FIG. 18, the information processing device 100 determines a risk degree of the mobile body 500 based on a detection result of the on-board device 530 (step S111).

The roadside machine 700 determines a risk degree of the mobile body 500 (step S711). For example, the roadside machine 700 determines a risk degree of the mobile body 500 located around the own machine. The roadside machine 700 generates determination information 722 indicating a determination result and stores the determination information 722 in the storing unit 720. The roadside machine 700 transmits the determination information 722 to the mobile body 500 via the communication unit 710 (step S712).

When receiving the determination information 722 from the roadside machine 700 via the communication unit 110, the information processing device 100 changes parameters and an importance degree based on the determination information 722 and the risk degree determined by the own device (step S141). For example, the information processing device 100 detects a suitability degree of the detection result of the on-board device 530 based on a comparison result of a determination result of the risk degree indicated by the determination information 722 of the roadside machine 700 and a determination result of the risk degree of the own device and customizes the parameters and the importance degree based on the suitability degree. As a result, the generating unit 134 starts generating control information based on the parameters after the change. The operation control unit 135 controls the operation of the mobile body 500 based on the control information.

The information processing device 100 generates the change information D200 indicating a change result (step S142). The information processing device 100 transmits the change information D200 to the first server 200A via the communication unit 110 (step S143). Note that, the timing at which the information processing device 100 transmits the change information D200 to the first server 200A includes, for example, periodic and a case where a set risk degree is determined.

The first server 200A stores the change information D200 received from the information processing device 100 via the communication unit 210 in the storing unit 220 (step S211). The first server 200A changes the parameter information D1 based on the change information D200 (step S212).

As explained above, in the information processing system 1 according to the second embodiment, the information processing device 100 can change parameters to parameters suitable for the mobile body 500 based on a determination result of the risk degree of the own device and the determination result of the risk degree of the roadside machine 700. As a result, the information processing system 1 can achieve optimization of the parameters used for the detection of the surrounding environment of the mobile body 500 by changing the parameters to parameters corresponding to the external environment of the mobile body 500 with the information processing device 100 and can contribute to improvement of safety in the movement of the mobile body 500.

Note that the second embodiment explained above shows an example and various modifications and applications are possible. The information processing system 1 in the second embodiment may be applied to other embodiments and the like.

[Hardware Configuration]

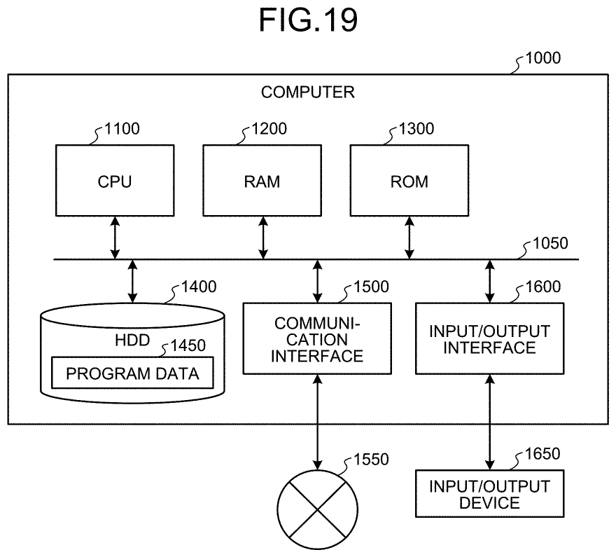

The information processing device according to the present embodiment explained above may be realized by, for example, a computer 1000 having a configuration illustrated in FIG. 19. In the following explanation, the information processing device 100 according to the embodiment is explained as an example. FIG. 19 is a hardware configuration diagram illustrating an example of a computer 1000 that realizes the functions of the information processing device 100. The computer 1000 includes a CPU 1100, a RAM 1200, a ROM (Read Only Memory) 1300, an HDD (Hard Disk Drive) 1400, a communication interface 1500, and an input/output interface 1600. The units of computer 1000 are connected by a bus 1050.

The CPU 1100 operates based on programs stored in the ROM 1300 or the HDD 1400 and performs control of the units. For example, the CPU 1100 develops the programs stored in the ROM 1300 or the HDD 1400 in the RAM 1200 and executes processing corresponding to various programs.

The ROM 1300 stores a boot program such as a BIOS (Basic Input Output System) executed by the CPU 1100 at a start time of the computer 1000, a program depending on hardware of the computer 1000, and the like.

The HDD 1400 is a computer-readable recording medium that non-temporarily records a program to be executed by the CPU 1100 and data used by the program. Specifically, the HDD 1400 is a recording medium for recording an information processing program according to the present disclosure, which is an example of program data 1450.

The communication interface 1500 is an interface for connecting the computer 1000 to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard or mouse via the input/output interface 1600. Further, the CPU 1100 transmits data to an output device such as a display, a speaker, or a printer via the input/output interface 1600. Further, the input/output interface 1600 may function as a media interface for reading a program or the like recorded on a predetermined recording medium. The medium is, for example, an optical recording medium such as a DVD (Digital Versatile Disc), a magneto-optical recording medium such as an MO (Magneto-Optical disk), a tape medium, a magnetic recording medium, or a semiconductor memory.

For example, when the computer 1000 functions as the information processing device 100 according to the embodiment, the CPU 1100 of the computer 1000 executes a program loaded on the RAM 1200 to thereby realize the functions of the acquiring unit 131, the setting unit 132, and the determining unit 133, the generating unit 134, the operation control unit 135, the transmitting unit 136, the reflecting unit 137, and the like of the control unit 130. Further, the HDD 1400 stores the program relating to the present disclosure and the data in the storing unit 120. The CPU 1100 reads the program data 1450 from the HDD 1400 and executes the program data 1450. However, as another example, these programs may be acquired from another device via the external network 1550.

The preferred embodiments of the present disclosure are explained in detail above with reference to the accompanying drawings. However, the technical scope of the present disclosure is not limited to such examples. It is evident that those having the ordinary knowledge in the technical field of the present disclosure can arrive at various alterations or corrections within the category of the technical idea described in claims. It is understood that these alterations and corrections naturally belong to the technical scope of the present disclosure.

The effects described in this specification are only explanatory or illustrative and are not limiting. That is, the technique according to the present disclosure can achieve other effects obvious for those skilled in the art from the description of this specification together with the effects or instead of the effects.

In addition, it is possible to create a program for hardware such as a CPU, a ROM, and a RAM built in a computer to exert the same functions as the functions of the components included in the information processing device 100. A computer-readable recording medium recording the program can also be provided.

In addition, the steps relating to the processing of the information processing system 1 of this specification do not always need to be processed in time series in the order described in the sequences. For example, the steps relating to the processing of the information processing system 1 may be processed in order different from the order described in the sequences or may be processed in parallel.

Further, in this specification, the case where the information processing device 100 is realized by the electronic control unit of the mobile body 500 is explained. However, the present disclosure is not limited to this. The information processing device 100 may be realized by other electronic control units such as an on-board device, a communication device, the drive system control unit 510, and the body system control unit 520 mounted on the mobile body 500.

(Effects)

The information processing device 100 is includes the storing unit 120 that stores the parameter information D1 relating to the parameters used for the detection of the surrounding environment of the mobile body 500 and the setting unit 132 that sets, based on the dynamic information detected outside the mobile body 500 and the parameter information D1, the parameters used for the detection of the surrounding environment of the mobile body 500.

As a result, the information processing device 100 can set, based on the dynamic information detected outside the mobile body 500 and the parameter information D1 of the own device, which cannot be detected by the mobile body 500, parameters used for detection of the surrounding environment of the mobile body 500. As a result, the information processing device 100 can achieve optimization of the parameters used for the detection of the surrounding environment of the mobile body 500 according to the external environment of the mobile body 500. Therefore, the information processing device 100 can contribute to improvement of safety in the movement of the mobile body 500.

In the information processing device 100, the parameter information D1 includes the plurality of parameters corresponding to the dynamic factors and the static factors. The setting unit 132 dynamically sets the parameters used for the detection of the surrounding environment of the mobile body 500 based on the dynamic information and the plurality of parameters.

Consequently, the information processing device 100 can set, according to the dynamic factors and the static factors, parameters used for detection of the surrounding environment of the mobile body out of the plurality of parameters corresponding to the dynamic factors and the static factors. As a result, the information processing device 100 can set parameters suitable for the dynamic factors and the static factors as the parameters used for the detection of the surrounding environment of the mobile body 500. Therefore, the information processing device 100 can contribute to further improvement of the safety in the movement of the mobile body 500.

The information processing device 100 further includes the acquiring unit 131 that acquires the dynamic map D100. The setting unit 132 dynamically sets, based on the dynamic information included in the acquired dynamic map D100, parameters used for detection of the surrounding environment of the mobile body 500.

Consequently, the information processing device 100 can set, based on the dynamic information of the dynamic map D100 detected outside the mobile body 500 and the parameter information D1 of the own device, the parameters used for the detection of the surrounding environment of the mobile body 500. As a result, the information processing device 100 can set parameters suitable for detecting the surrounding environment of the mobile body 500 according to the dynamic information of the dynamic map D100. Therefore, the information processing device 100 can contribute to improvement of safety in the movement of the mobile body 500.

In the information processing device 100, the setting unit 132 sets, based on the static information included in the acquired dynamic map D100, the parameters used for the detection of the surrounding environment of the mobile body 500.

Consequently, the information processing device 100 can set, based on the static information of the dynamic map D100 detected outside the mobile body 500 and the parameter information D1 of the own device, the parameters used for the detection of the surrounding environment of the mobile body 500. As a result, the information processing device 100 can set parameters suitable for detecting the surrounding environment of the mobile body 500 according to the static information of the dynamic map D100. Therefore, the information processing device 100 can improve convenience of the plurality of parameters used for controlling the mobile body 500. That is, the information processing device 100 can set parameters suitable for detecting the surrounding environment of the mobile body 500 according to the dynamic information and the static information of the dynamic map D100. Therefore, the information processing device 100 can set more optimum parameters.

In the information processing device 100, the setting unit 132 sets the parameters used for the detection of the surrounding environment of the mobile body 500 when the dynamic map D100 is updated.

Consequently, the information processing device 100 can dynamically set, based on the updated dynamic map D100, the parameters used for the detection of the surrounding environment of the mobile body 500. As a result, the information processing device 100 can reflect a change of the dynamic map D100 on the parameters of the mobile body 500. Therefore, the information processing device 100 can improve detection accuracy of the surrounding environment of the mobile body 500.

In the information processing device 100, the parameter information D1 includes the parameters and the importance degree of the detection result of the sensor for detecting the surrounding environment. The setting unit 132 changes the importance degree of the parameter information D1 based on at least one of the dynamic information and the static information.

Consequently, the information processing device 100 can change, based on at least one of the dynamic information and the static information of the dynamic map D100, the importance degree of the detection result of the sensor based on the parameters. As a result, the information processing device 100 can improve the reliability of the detection result by using the detection result of the sensor based on the importance degree.

The information processing device 100 further includes the determining unit 133 that determines a risk degree of the mobile body 500 based on the detection result. The setting unit 132 changes the parameter information D1 based on the risk degree determined by the determining unit 133.

Consequently, the information processing device 100 can customize the parameter information D1 by determining a risk degree of the mobile body 500 based on the detection result of the sensor and changing the parameter information D1 based on the risk degree. As a result, the information processing device 100 can set parameters according to the risk degree of the mobile body 500. Therefore, the information processing device 100 can further improve the safety in the movement of the mobile body 500

The information processing device 100 further includes the generating unit 134 that generates, based on the determination result of the determining unit 133, control information for controlling the mobile body 500.

Consequently, when the information processing device 100 determines a risk degree of the mobile body 500, the information processing device 100 can generate control information corresponding to a result of the determination. For example, when a human is driving the mobile body 500, the information processing device 100 can control the movement of the mobile body 500 via the human by providing the control information to the driver. As a result, the information processing device 100 can further improve the safety in the movement by contributing to improvement of a risk degree of the mobile body 500 by generating the control information for improving the risk degree of the mobile body 500.

The information processing device 100 further includes the operation control unit 135 that controls the operation of the mobile body 500 based on the control information.

Consequently, the information processing device 100 can control the operation of the mobile body 500 based on the control information generated according to the determination of the risk degree. As a result, the information processing device 100 can suppress an increase in the risk degree of the mobile body 500 with the control information for improving the risk degree of the mobile body 500. Therefore, the information processing device 100 can further improve the safety in movement.

The information processing device 100 further includes the transmitting unit 136 that transmits the change information D200 obtained by changing the parameter information D1 based on the risk degree to the outside of the mobile body 500.

Consequently, when changing the parameter information D1 based on the risk degree, the information processing device 100 can transmit the change information D200 indicating the change to the outside of the mobile body 500. As a result, the information processing device 100 can contribute to the change, optimization, and the like of the parameter information D1 with the transmitted change information D200. Therefore, the information processing device 100 can achieve improvement of the safety in the movement of the mobile body 500 by the changed parameter information D1.

The information processing device 100 further includes the reflecting unit 137 that reflects the change information D200 transmitted by the other mobile body 500 on the parameter information D1 stored in the storing unit 120.

Consequently, the information processing device 100 can reflect the change information D200 of the other mobile body 500 on the parameter information D1 of the own device. As a result, the information processing device 100 can further improve the safety in the movement by reflecting a change result corresponding to a risk degree of the other mobile body 500 on the parameter information D1.

The information processing system 1 includes the information processing device 100 and the first server (providing device) 200A that provides, to the information processing device 100, parameter information concerning parameters used for detection of the surrounding environment of the mobile body 500. The information processing device 100 includes the storing unit 120 that stores the parameter information D1 provided by the first server 200A and the setting unit 132 that sets, based on the dynamic information detected outside the mobile body 500 and the parameter information D1, parameters used for detection of the surrounding environment of the mobile body 500.

Consequently, in the information processing system 1, the information processing device 100 can dynamically set, based on the dynamic information detected outside the mobile body 500 and the parameter information D1 of the own device, which cannot be detected by the mobile body 500, parameters used for detection of the surrounding environment of the mobile body 500. As a result, the information processing system 1 can achieve optimization of the parameters used for the detection of the surrounding environment of the mobile body 500 according to the external environment of the mobile body 500. Therefore, the information processing system 1 can contribute to improvement of the safety in the movement of the mobile body 500.

In the information processing system 1, the first server 200A provides the parameter information D1 corresponding to at least one of the type of the mobile body 500 and the driving preference to the information processing device 100.

Consequently, in the information processing system 1, the information processing device 100 can set parameters suitable for dynamic information from the parameter information D1 suitable for the type of the mobile body 500 and the driving preference. As a result, the information processing system 1 can achieve optimization of the parameters suitable for the movement of the mobile body 500 set according to the external environment of the mobile body 500. Therefore, the information processing system 1 can contribute to improvement of the safety in the movement of the mobile body 500.

In the information processing system 1, the information processing device 100 further includes the transmitting unit 136 that transmits the change information D200 obtained by changing the parameter information D1 stored in the storing unit 120 to the first server 200A. The first server 200A includes the changing unit 232 that changes, based on the change information D200 of the information processing device 100, the parameter information D1 provided to the information processing device 100.

Consequently, the information processing system 1 can change, based on the change information D200 from the information processing device 100 of the mobile body 500, the parameter information D1 provided to the information processing device 100. As a result, the information processing system 1 can achieve optimization of the parameter information D1 provided to the information processing device 100. Therefore, the information processing system 1 can further improve the safety in the movement.

In the information processing system 1, the information processing device 100 further includes the reflecting unit 137 that reflects, based on the update frequency of the parameter information D1 stored in the storing unit 120, the parameter information D1 provided by the first server 200A on the parameter information D stored in the storing unit 120.

Consequently, in the information processing system 1, the information processing device 100 can reflect the parameter information D1 from the first server 200A based on the update frequency of the parameter information D1 of the own device. As a result, the information processing system 1 can avoid changing the parameter information D1 changed by the information processing device 100 with the parameter information D1 from the first server 200A. Therefore, the information processing system 1 can improve the convenience of the parameter information D1.

The information processing method includes the computer storing the parameter information D1 concerning the parameters used for the detection of the surrounding environment of the mobile body 500 in the storing unit 120 and setting, based on the dynamic information detected outside the mobile body 500 and the parameter information D1 parameters used for detection of the surrounding environment of the mobile body 500.

Consequently, in the information processing method, the computer can dynamically set, based on the dynamic information detected outside the mobile body 500 and the parameter information D1 of the own device, which cannot be detected by the mobile body 500, parameters used for detection of the surrounding environment of the mobile body 500. As a result, the information processing method can achieve optimization of the parameters used for the detection of the surrounding environment of the mobile body 500 according to the external environment of the mobile body 500. Therefore, the information processing method can contribute to improvement of the safety in the movement of the mobile body 500.

Note that the following configurations also belong to the technical scope of the present disclosure.

(1)

An information processing device comprising:

a storing unit that stores parameter information concerning parameters used for detection of a surrounding environment of a mobile body; and

a setting unit that sets the parameters used for the detection of the surrounding environment of the mobile body based on dynamic information detected outside the mobile body and the parameter information.

(2)

The information processing device according to (1), wherein

the parameter information includes a plurality of parameters corresponding to dynamic factors and static factors, and

the setting unit sets, based on the dynamic information and a plurality of parameters, the parameters used for the detection of the surrounding environment of the mobile body.

(3)

The information processing device according to (1) or (2), further comprising

an acquiring unit that acquires a dynamic map, wherein

the setting unit sets, based on the dynamic information included in the acquired dynamic map, the parameters used for the detection of the surrounding environment of the mobile body.

(4)

The information processing device according to (3), wherein

the setting unit sets, based on static information included in the acquired dynamic map, the parameters used for the detection of the surrounding environment of the mobile body.

(5)

The information processing device according to (3) or (4), wherein,

when the dynamic map is updated, the setting unit sets the parameters used for the detection of the surrounding environment of the mobile body.

(6)

The information processing device according to (4), wherein

the parameter information includes the parameters and an importance degree of a detection result of a sensor for detecting the surrounding environment, and

the setting unit changes the importance degree based on at least one of the dynamic information and the static information.

(7)

The information processing device according to (6), further comprising

a determining unit that determines a risk degree of the mobile body based on the detection result, wherein

the setting unit changes the parameter information based on the risk degree determined by the determining unit.

(8)

The information processing device according to (7), further comprising

a generating unit that generates, based on the determination result of the determining unit, control information for controlling the mobile body.

(9)

The information processing device according to (8), further comprising

an operation control unit that controls operation of the mobile body based on the control information.

(10)

The information processing device according to (8) or (9), further comprising

a transmitting unit that transmits change information obtained by changing the parameter information based on the risk degree to an outside of the mobile body.

(11)

The information processing device according to (10), further comprising

a reflecting unit that reflects the change information transmitted by another mobile body on the parameter information stored in the storing unit.

(12)

An information processing system comprising:

an information processing device; and a providing device that provides parameter information concerning parameters used for detection of a surrounding environment of a mobile body to the information processing device, wherein

the information processing device includes:

a storing unit that stores the parameter information provided by the providing device; and

a setting unit that sets, based on dynamic information detected outside the mobile body and the parameter information, the parameters used for the detection of the surrounding environment of the mobile body.

(13)

The information processing system according to (12), wherein

the providing device provides the parameter information corresponding to at least one of a type of the mobile body and a driving preference to the information processing device.

(14)

The information processing system according to (12) or (13), wherein

the information processing device further includes a transmitting unit that transmits change information obtained by changing the parameter information stored in the storing unit to the providing device, and

the providing device includes a changing unit that changes, based on the change information of the information processing device, the parameter information provided to the information processing device.

(15)

The information processing system according to any one of (12) or (14), wherein

the information processing device further includes a reflecting unit that reflects, based on an update frequency of the parameter information stored in the storing unit, the parameter information provided by the providing device on the parameter information stored in the storing unit.

(16)

An information processing method, by a computer, comprising:

storing parameter information concerning parameters used for detection of a surrounding environment of a mobile body in a storing unit; and

setting, based on dynamic information detected outside the mobile body and the parameter information, the parameters used for the detection of the surrounding environment of the mobile body.

(17)

A program for causing a computer to realize:

storing, in a storing unit, parameter information concerning parameters used for detection of a surrounding environment of a mobile body; and

setting, based on dynamic information detected outside the mobile body and the parameter information, parameters used for detection of the surrounding environment of the mobile body.

### REFERENCE SIGNS LIST

1 INFORMATION PROCESSING SYSTEM
100 INFORMATION PROCESSING DEVICE
110 COMMUNICATION UNIT
120 STORING UNIT
130 CONTROL UNIT
131 ACQUIRING UNIT
132 SETTING UNIT
133 DETERMINING UNIT
134 GENERATING UNIT
135 OPERATION CONTROL UNIT
136 TRANSMITTING UNIT
137 REFLECTING UNIT
200A FIRST SERVER
200B SECOND SERVER
210 COMMUNICATION UNIT
220 STORING UNIT
230 CONTROL UNIT
231 PROVIDING UNIT
232 CHANGING UNIT
233 GENERATING UNIT
234 TRANSMITTING UNIT
500 MOBILE BODY
530 ON-BOARD DEVICE
700 ROADSIDE MACHINE
710 COMMUNICATION UNIT
720 STORING UNIT
730 CONTROL UNIT
740 SENSOR UNIT
D1 PARAMETER INFORMATION
D100 DYNAMIC MAP
D200 CHANGE INFORMATION

1. An information processing device comprising:
a storing unit that stores parameter information concerning parameters used for detection of a surrounding environment of a mobile body; and
a setting unit that sets the parameters used for the detection of the surrounding environment of the mobile body based on dynamic information detected outside the mobile body and the parameter information.

2. The information processing device according to claim 1, wherein
the parameter information includes a plurality of parameters corresponding to dynamic factors and static factors, and
the setting unit sets, based on the dynamic information and a plurality of parameters, the parameters used for the detection of the surrounding environment of the mobile body.

3. The information processing device according to claim 2, further comprising
an acquiring unit that acquires a dynamic map, wherein
the setting unit sets, based on the dynamic information included in the acquired dynamic map, the parameters used for the detection of the surrounding environment of the mobile body.

4. The information processing device according to claim 3, wherein
the setting unit sets, based on static information included in the acquired dynamic map, the parameters used for the detection of the surrounding environment of the mobile body.

5. The information processing device according to claim 4, wherein,
when the dynamic map is updated, the setting unit sets the parameters used for the detection of the surrounding environment of the mobile body.

6. The information processing device according to claim 4, wherein
the parameter information includes the parameters and an importance degree of a detection result of a sensor for detecting the surrounding environment, and
the setting unit changes the importance degree based on at least one of the dynamic information and the static information.

7. The information processing device according to claim 6, further comprising
a determining unit that determines a risk degree of the mobile body based on the detection result, wherein
the setting unit changes the parameter information based on the risk degree determined by the determining unit.

8. The information processing device according to claim 7, further comprising
a generating unit that generates, based on the determination result of the determining unit, control information for controlling the mobile body.

9. The information processing device according to claim 8, further comprising
an operation control unit that controls operation of the mobile body based on the control information.

10. The information processing device according to claim 8, further comprising
a transmitting unit that transmits change information obtained by changing the parameter information based on the risk degree to an outside of the mobile body.

11. The information processing device according to claim 10, further comprising
a reflecting unit that reflects the change information transmitted by another mobile body on the parameter information stored in the storing unit.

12. An information processing system comprising:
an information processing device; and
a providing device that provides parameter information concerning parameters used for detection of a surrounding environment of a mobile body to the information processing device, wherein
the information processing device includes:
a storing unit that stores the parameter information provided by the providing device; and
a setting unit that sets, based on dynamic information detected outside the mobile body and the parameter information, the parameters used for the detection of the surrounding environment of the mobile body.

13. The information processing system according to claim 12, wherein
the providing device provides the parameter information corresponding to at least one of a type of the mobile body and a driving preference to the information processing device.

14. The information processing system according to claim 12, wherein
the information processing device further includes a transmitting unit that transmits change information obtained by changing the parameter information stored in the storing unit to the providing device, and
the providing device includes a changing unit that changes, based on the change information of the information processing device, the parameter information provided to the information processing device.

15. The information processing system according to claim 12, wherein
the information processing device further includes a reflecting unit that reflects, based on an update frequency of the parameter information stored in the storing unit, the parameter information provided by the providing device on the parameter information stored in the storing unit.

16. An information processing method, by a computer, comprising:
storing parameter information concerning parameters used for detection of a surrounding environment of a mobile body in a storing unit; and
setting, based on dynamic information detected outside the mobile body and the parameter information, the parameters used for the detection of the surrounding environment of the mobile body.
